(19) United States
(12) Patent Application Publication
(10) Pub. No.: US 2009/0007365 A1
(43) Pub. Date: Jan. 8, 2009

(54) Wiper Arm

(75) Inventors: Bruno Egner-Walter, Heilbronn (DE); Michael Schauble, Vaihingen/Enz (DE)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, La Verriere (FR)

(21) Appl. No.: 12/161,595

(22) PCT Filed: Jan. 25, 2007
(86) PCT No.: PCT/EP2007/000628

§ 371 Date: Jul. 21, 2008

(30) Foreign Application Priority Data
Jan. 28, 2006 (DE) 10 2006 004 110.0

(51) Int. Cl. B60S 1/40

(52) U.S. Cl. 15/250.32

(57) ABSTRACT

A wiper arm for wiper systems of road vehicles including a wiper blade adapter attached via a connection at one end of a non-circular-shaped wiper arm element and a retainer, where the wiper blade adapter is designed for connection to a wiper blade, and the wiper arm element and the retainer are swivel-mounted to a retainer support attachable in a torque proof manner to a drivable wiper shaft, where the wiper arm element and the retainer are capable of being stressed against a screen to be wiped by a spring element provided on the wiper arm, where the connection is performed by at least one connecting piece which is formed on a circumferential surface rotationally and symmetrically with respect to a connecting piece axis.

The invention concerns a wiper arm according to the generic term of patent claim 1.

Wiper arms with a wiper blade adapter provided at one wiper arm end for detachable fixing of a wiper blade are known in the widest variety of embodiments. Often also used are wiper arms that essentially consist of a rod-like wiper arm element or wiper arm rod which is rectangular in cross section, which have the wiper blade adapter at one end and are articulated at the other end by means of a retainer, with for example an at least partly U profile shape, to a retainer support attachable to a wiper shaft. Wiper arms of this type possess sufficient rigidity inspite of a small rod cross-section in the wiping direction, so that they can fulfil in a particularly advantageous manner the at least partly contradictory requirements for the highest possible rigidity, the least possible weight and the best possible visibility conditions.

Known furthermore are wiper arms, the wiper arm rods of which are formed of a solid round material (U.S. Pat. No. 1,942,661) or a tube profile (EP 0 566 471), though these wiper arms however, among other aspects, do not or only insufficiently fulfil the requirements with respect to rigidity, weight ratio and best possible visibility conditions.

The purpose behind the invention is to demonstrate a wiper arm that possesses at its end having the wiper blade adapter a cross-section differing from a circular shape, i.e. preferably a rectangular-shaped or U profile-shaped cross-section and can be manufactured cheaply with high precision, particularly also with regard to the orientation of the wiper blade adapter. In order to fulfil this task, a wiper arm according to patent claim 1 is designed.

Unlike known wiper arms, the wiper blade adapter is not fixed directly to the rod-like wiper element which is for example rectangular or U-shaped in cross-section, but through a connection that has at least one connecting piece which is formed on its outer surface around an axis extending between the wiper arm and the wiper blade adapter symmetrically to rotation and is encompassed by an element of the connection connected to the wiper blade adapter or the rod-like wiper arm element. As a result, during manufacture of the wiper arm, simple adjustment and alignment of the wiper blade adapter is possible by rotating the wiper blade adapter around the axis of the connecting piece and/or by axial displacement in the direction of this axis. After this alignment, the connecting piece and the element of the connection surrounding this connecting piece are fixed on to one another in a torque-proof manner, to be more precise by pressing or crimping, gluing, or in another suitable manner.

The connecting piece, which is for example a pin or a bolt with a cylindrical circumferential surface, is held on the wiper arm element and/or on the wiper blade adapter for example by a connecting bush or held such that the connecting piece is received in an area created for example by permanent material deformation (e.g. crimping) in the rod-like wiper arm element or the wiper blade adapter. Other types of fixing are also possible. It is possible in particular to manufacture is the connecting piece in a single piece with the wiper blade adapter.

Further developments of the invention are the subject of the subclaims. The invention is explained in further detail below based on the figures by examples of embodiment.

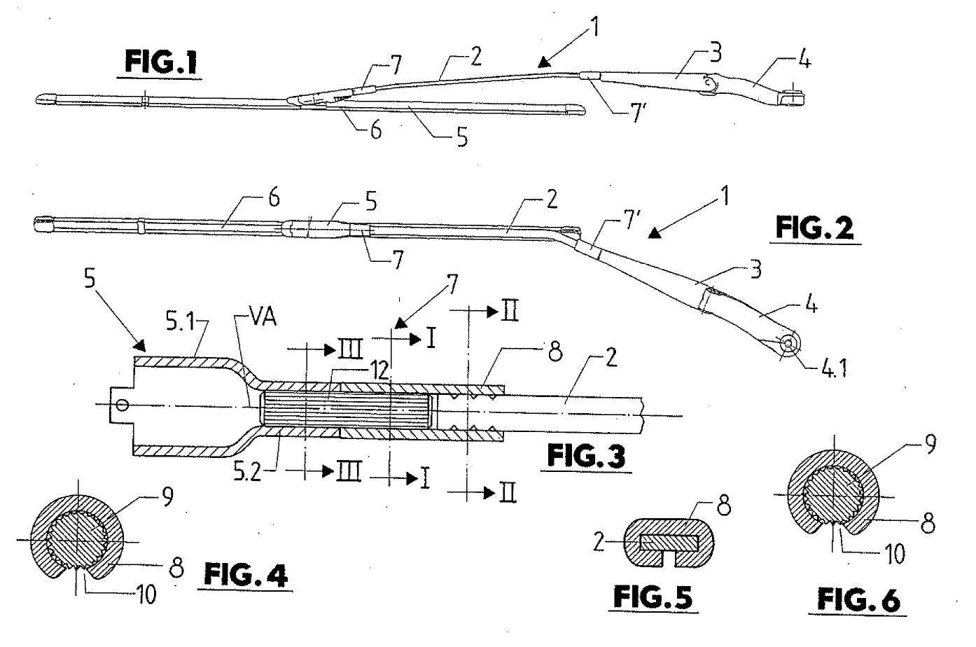

FIGS. 1 and 2 show the wiper arm in addition to the wiper blade fixed to the latter of an otherwise non-illustrated windscreen wiper module for vehicles, particularly road vehicles, in a side view and top view;

FIG. 3 shows the wiper arm end together with the wiper blade adapter connected by means of a connecting piece;

FIG. 4 shows a cross-section corresponding to the line I-I of FIG. 3;

FIG. 5 shows a cross-section corresponding to the line II-II of FIG. 3;

FIG. 6 shows a cross-section corresponding to the line III-III of FIG. 3;

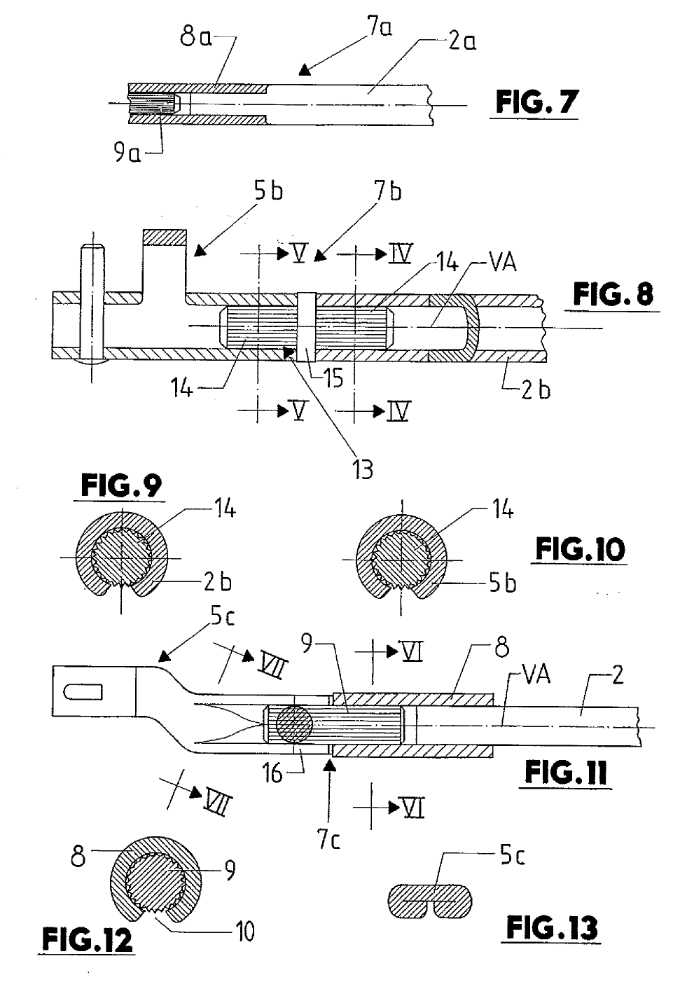

FIG. 7 shows in a presentation similar to FIG. 3 the wiper arm end together with the connecting piece in a further possible form of embodiment;

FIG. 8 shows a presentation as in FIG. 3 with a further form of embodiment;

FIG. 9 shows a cross-section corresponding to the line IV-IV of FIG. 8;

FIG. 10 shows a cross-section corresponding to the line V-V of FIG. 8;

FIG. 11 shows a presentation similar to that of FIG. 3 with a further form of embodiment;

FIG. 12 shows a cross-section corresponding to the line VI-VI of FIG. 11;

FIG. 13 shows a cross-section corresponding to the line VII-VII of FIG. 11;

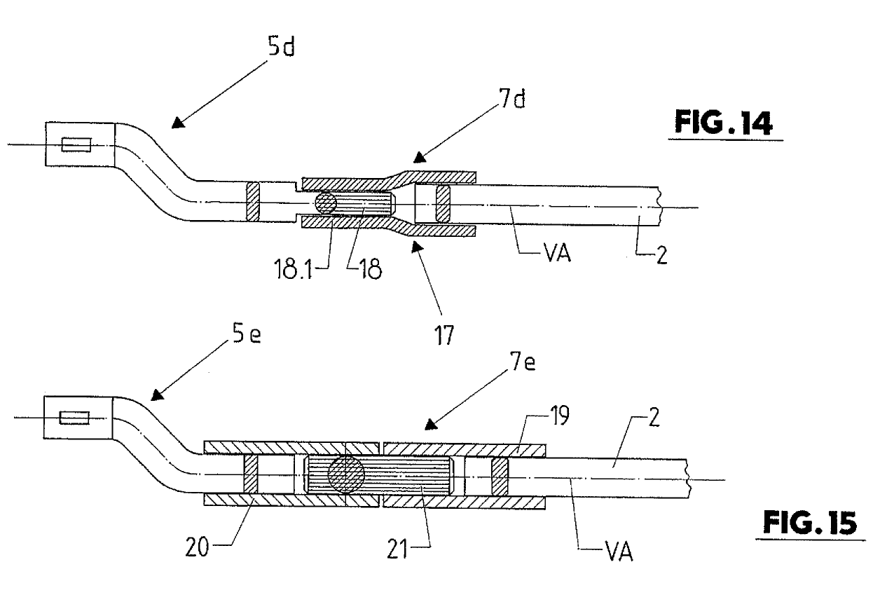

FIGS. 14 and 15 shows presentations similar to those of FIG. 11 respectively with other forms of embodiment of the invention.

A wiper arm 1 of a wiper model for road vehicles is presented in FIGS. 1-6. This wiper arm 1 costs among other aspects of the wiper arm rod 2, which is manufactured from strip-like steel material and has a rectangular cross-section. At one end of the wiper arm rod 2, a retainer 3 is usually attached, which is manufactured from sheet steel for example with an essentially U-shaped profile and by means of which the wiper arm rod 2 is articulated to a retainer support 4, which, with the wiper arm 1 installed, is attached with an opening 4.1 to the non-illustrated wiper shaft. At the other end of the wiper arm rod 2, a wiper blade adapter 5 with the wiper blade 6 with provision for replacement is attached, which is designed as a flat wiper blade in this embodiment. In this respect, the wiper arm 1 including the wiper arm adapter 5 and the wiper blade fundamentally corresponds to the known design for windscreen wiper modules.

The particularity of the wiper arm 1 lies in the fact that the wiper blade adapter 5 is not directly attached to the wiper arm rod 2, but is attached by means of a connection which is generally denoted by 7 in FIGS. 1-3 and which consists of a connecting bush 5 and a bolt 9 as a connecting piece made of metal respectively, for example steel, in the form of embodiment presented. The connecting bush 8 is manufactured with a continuous elongated slot 10, for example by rolling the metallic flat material (e.g. sheet steel). The bolt 9 is provided on its outer surface with knurling or with profiling extending in the longitudinal direction of the bolt, for example in the form of projections and intermediate notches. The wiper blade adapter in this form of embodiment is likewise executed in sheet metal with a U profile section 5.1 overlapping the wiper blade 6 and an adapter element fixed at this position and articulated to this adapter element, in addition to an originally C-shaped profile section 5.2 of lesser width.

In order to connect the wiper blade adapter 5 to the wiper arm rod 2, a partial length of the bolt 9 is introduced into one end of the connecting bush 8 such that it projects by part of its length over this end and only takes up part of the length of the connecting bush 8. Finally, the other end of the connecting bush 8 is pushed on to the end of the wiper arm rod 2 to the connected to the wiper blade adapter 5. By permanent deformation (e.g. crimping) of the connecting bush 8, the bolt 9 is connected to the wiper rod 2. The bolt 9 to be connected to the wiper rod 2 is subsequently arranged in the same axis as the axis of the wiper rod end. In order to achieve a particularly firm connection between the connecting bush 8 and the wiper rod 2, the end of the latter is provided with profiling, for example in the form of indentations 12. After fixing the bolt 9 to the wiper rod 2, the wiper blade support 5 is attached to the bolt 9, to be more precise by placing the sides of the profile section 5.2 around the bolt 9.

FIGS. 4 and 5 show the design of the connection between the connecting bush 8 and the bolt 9 and the wiper arm rod 2. FIG. 6 shows the design of the connection between the bolt 9 and the wiper blade adapter 5.

With this installation, it is possible to easily align the wiper blade adapter 5, even with a wiper arm rod 2 with several curves, by rotation around the axis of the bolt 9 and the connecting piece axis VA and also by axial displacement on the bolt, for example in relation to the axis of the drilling hole or opening 4.1 in the retainer support 4. The wiper arm 1 with the wiper blade adapter 5 can therefore be manufactured with very low tolerances and to be more precise even if in order to reduce the production costs for example during manufacture and installation of the part of the wiper arm 1 consisting of the wiper arm rod 2, the retainer 3 and the retainer support 4, high tolerances are allowed. In particular, adjustment and therefore compensation of tolerances is possible with the connection 7.

The connection 7 furthermore makes it possible to provide different wiper blade adapters, for example corresponding to the customer's wishes, on one and the same wiper arm 1 and to be more precise with maintenance of uniform manufacture for the part of the wiper arm 1 consisting of the wiper blade rod 2, the retainer 3 and the retainer support 4.

FIG. 7 shows in a presentation as in FIG. 3 a connection 7a, which in turn consists of a connection bush 8a corresponding to the connecting bush 8 and a bolt 9a corresponding to the bolt 9. In this embodiment, the wiper arm rod 2a is reduced in width at its end such that the attached connecting bush 8a in a top view of the wiper arm rod 2a does not project over the latter's longitudinal or narrow side and a visually particularly appealing appearance results. In this embodiment also, the end of the wiper arm rod 2a surrounded by the connecting bush 8a has a cross-section different from a circular shape, i.e. a slightly rectangular-shaped or at least square cross-section.

FIGS. 8-10 show a form of embodiment in which the wiper arm rod 2a and the part of the wiper arm forming this rod have a U-shaped cross-section and the wiper blade adapter 5b is connected by means of the connection 7b to the end of the wiper arm rod 2b. The connecting piece in this embodiment is a bolt 13 with two bolt sections 14 of identical axial length and with a collar 15 formed between these bolt sections. Both bolt sections present in turn the knurling or profiling 11. During manufacture, the bolt 13 and a bolt section 14 are fixed on this rod by permanent distortion and placing around of the sides of the wiper arm rod 2b, i.e. by crimping for example (FIG. 9) and to be more precise, such that the collar 15 lies against the end of the wiper arm rod 2b. The wiper blade adapter 5b is likewise fixed by permanent deformation of the sides of its U profile or C profile, i.e. by crimping to the other bolt section 14 (FIG. 10).

The wiper arm section 2b and wiper blade adapter 5b are manufactured in turn from sheet metal or sheet steel.

FIGS. 11-13 once again show an embodiment in which a wiper blade adapter 5c in the form of a so-called hook for a non-illustrated stirrup wiper blade is fixed to the wiper arm rod 2 manufactured from the strip-like flat material by means of the connection 7c formed by the connecting bush 8 and the bolt 9. The wiper blade adapter 5c is manufactured from sheet metal by punching and bending and to be more precise, with an initially C-shaped profile section 16 with which the wiper blade adapter 5c is subsequently fixed to the end of the bolt 9 projecting from the connecting bush 8 by permanent deformation of this C profile section (e.g. by crimping).

FIG. 14 shows as a further embodiment in a similar presentation to FIG. 11 a connection 7d for connecting the wiper blade adapter 5d to the wiper arm rod 2. The connecting piece is formed in this embodiment by a bolt-like section 18 of the wiper blade adapter 5d encompassed by the connecting bush 17. The connecting bush 17 is for example designed according to the connecting bush 8 and to be more precise again by rolling from sheet steel. The connecting arm adapter 5d is manufactured as a moulded component from suitable material, for example as a injection moulded component made of metal or an injection moulded component made of a suitable material and is in turn executed as a so-called “hook” for detachable fixing of a non-illustrated stirrup wiper blade. At its end to the connected to the wiper arm rod 2 via the connection 7d, the wiper blade adapter 5d with the section 18 is designed with a circular cylindrical-shaped cross-section, equipped on its outer surface with longitudinal profiling corresponding to the knurling or profiling 11. Installation is performed in this embodiment for example such that the bush 17 is initially fixed to the wiper arm rod 2 by permanent distortion or crimping. The wiper blade adapter 5d is subsequently installed by inserting the section 18 into the part of the connecting bush 17 not taken up by the wiper arm rod 2 and by pressing (crimping) the connecting bush 17 on the section 18.

FIG. 15 shows as a further form of embodiment a connection 7e for connecting the wiper arm rod 2 to a wiper blade adapter 5e manufactured for example by punching and bending and designed as a so-called hook. The connection 7e consists in this form of embodiment of two connecting bushes 19 and 20 corresponding to the connecting bush 8 and the bolt 21 corresponding to the bolts 9. During installation, the connecting bush 19 and the bolt 21 are for example initially installed by pressing (crimping) in such a manner that part of the length of the bolt 21 held in the connecting bush 19 projects out of the connecting bush 19. Subsequently, the bolt 21 and the wiper blade adapter 5e are connected by means of the connecting bush 20 by pressing this bush.

In the embodiments in FIGS. 7-14 also, the circular cylindrical-shaped cross-section of the corresponding connecting piece allows adjustment and alignment of the respective wiper blade adapter by rotation around the axis of the connecting piece and/or by axial displacement.

The invention has been described above in different examples of embodiment. It is understood that many modifications and variations are possible without departing as a result from the underlying conception of the invention.

It was therefore assumed above that the connecting bushes 8, 8a, 17, 19, 20 respectively consist of metallic material and are fixed to the elements to be connected by permanent distortion or pressing. It is basically also possible to manufacture such connecting bushes from plastic and fix them to the elements to be connected by suitable means, for example by gluing.

Furthermore, it is possible for example to design the respective connecting piece with a slight cone shape over part of its length, as implied by the dashed line 18.1 in FIG. 14.

Furthermore, it is also possible to provide, instead of the connection 7, 7a-7e, or in addition to the latter, a corresponding connection between the wiper rod and the retainer 3, as implied by 7′ in FIGS. 1 and 2. However, the embodiment with a connection 7, 7a-7e or a similar connection only at the end on the wiper blade side of the wiper arm, i.e. between the wiper arm element and the wiper arm rod and the wiper blade adapter is the preferred execution of the invention.

### LIST OF REFERENCES

1 Wiper arm
2, 2a, 2b Wiper arm rod
3 Retainer
4 Retainer support
4.1 Fixing opening for wiper shaft
5, 5b, 5c, 5d, 5e Wiper blade carrier
6 Wiper blade
7, 7′, 7a, 7b, 7c, 7d, 7e Connection
8 Connecting bush
9 Bolt or connecting piece
10 Elongated slot
11 Knurling or profiling
12 Indentation
13 Bolt or connecting piece
14 Bolt section
15 Collar
16 C profile section
17 Connecting bush
18 Fixing section
18.1 Line
19, 20 Connecting bush
21 Bolt or connecting piece
VA Connecting piece axis

1. A wiper arm for wiper systems of road vehicles comprising:
a wiper blade adapter which is attached via a connection at one end of a non-circular-shaped wiper arm element and a retainer,
wherein the wiper blade adapter is designed for connection to a wiper blade, and the wiper arm element and the retainer are swivel-mounted to a retainer support, wherein the retainer support is attachable in a torque proof manner to a drivable wiper shaft,
wherein the wiper arm element and the retainer are capable of being stressed against a screen to be wiped by a spring element provided on the wiper arm,
wherein the connection is performed by at least one connecting piece which is formed on a circumferential surface rotationally and symmetrically with respect to a connecting piece axis.

2. The wiper arm according to claim 1, wherein the at least one connecting piece is formed on its circumferential surface rotationally and symmetrically with respect to a connecting piece axis which extends between the wiper arm element and the wiper blade adapter.

3. The wiper arm according to claim 1, wherein at least one connecting piece is held on the end of the wiper arm section by means of a connecting bush.

4. The wiper arm according to claim 3, wherein the at least one connecting piece is held on the end of the wiper arm section by pressing of the connecting bush.

5. The wiper arm according to claim 1, wherein the at least one connecting piece is held on the end of the wiper arm section by pressing or distorting the wiper arm element in the area of its end to be connected to the wiper blade adapter.

6. The wiper arm according to claim 1, wherein the at least one connecting piece is held on the wiper blade adapter.

7. The wiper arm according to claim 6, wherein the at least one connecting piece is held on the wiper blade adapter using a connecting bush.

8. The wiper arm according to claim 7, wherein the at least one connecting piece is held on the wiper blade adapter by pressing the connecting bush.

9. The wiper arm according to claim 6, wherein the at least one connecting piece is held on the wiper blade adapter by pressing or deformation of a part of the wiper blade adapter.

10. The wiper arm according to claim 1, wherein the at least one connecting piece is designed as a section of the wiper blade adapter.

11. The wiper arm according to claim 1, wherein the at least one connecting piece has a circular cylindrical circumferential surface.

12. The wiper arm according to claim 1, wherein the at least one connecting piece has a cross-section that changes at least once along the connecting piece axis.

13. The wiper arm according to claim 12, wherein the at least one connecting piece has a cone-shaped or blunt cone-shaped circumferential surface over at least part of its length.

14. The wiper arm according to claim 1, wherein that the wiper arm element is designed as a flat wiper arm rod at least on its end to be connected to the wiper blade adapter.

15. The wiper arm according to claim 1, wherein the wiper element is designed as a U profile or C profile at least at the end to be connected to the wiper blade adapter.
